(19) United States
(12) Patent Application Publication
(10) Pub. No.: US 2009/0172003 A1
(43) Pub. Date: Jul. 2, 2009

(54) Secondary Persistencies in a Service-Oriented Business Framework

(76) Inventors: Frank Jentsch, Muehlhausen (DE); Martin Mueller, Walldorf (DE); Torsten Bachmann, St. Leon-Rot (DE); Frank Brunswig, Heidelberg (DE); Wolfgang Pfeiffer, Kerzenheim (DE); Jan Teichmann, Neustadt an de Weinstrasse (DE); Maic Wintel, Walldorf (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 11/965,701

(22) Filed: Dec. 27, 2007

(51) Int. Cl. G06F 17/30

(52) U.S. Cl. 707/102; 707/E17.044

(57) ABSTRACT

It is determined whether at least one request to replicate at least one business object is valid. The business object comprising a plurality of hierarchically arranged nodes, with a root node on a first end, at least one leaf node on a second end, and at least one intermediate node disposed between the root node and the at least one leaf node. Thereafter, a valid path from the root node to replication nodes within each business object specified in the at least one request is determined if it was determined that corresponding request is valid. A replication tree is then generated based on the determined valid path. The replication tree is then traversed and an association is returned when stopping on a leaf node and a replication node is returned when traversing a node to be replicated. A retrieve by association service is executed when an association is returned, otherwise, a retrieve service is executed. Thereafter, nodes retrieved via the retrieve by association service or the retrieve service are stored in a replication store using packages having a fixed size to enable the replication store to be searched. Related techniques, apparatus, systems, and articles are also described.

### TECHNICAL FIELD

The subject matter described herein relates to secondary persistencies in a framework such as a service-oriented business framework.

### BACKGROUND

Business objects are hierarchical data structures that include a root node on one end, at least one leaf node on another end, and at least one internal node disposed between the root node and a leaf node. As the number of nodes increases, so does the complexity of a business object. As a result, queries against such business objects can consume increasing amounts of processing resources as well as memory. In order to provide more rapid results to queries, architectures have been used in which at least a portion of a primary database is replicated in a secondary persistency and queries are conducted against this secondary persistency. However, replication of business objects from the primary database to the secondary persistency can consume unnecessary processing resources as well as memory.

### SUMMARY

In one aspect, it is determined whether at least one request to replicate at least one business object is valid. The business object comprising a plurality of hierarchically arranged nodes, with a root node on a first end, at least one leaf node on a second end, and at least one intermediate node disposed between the root node and the at least one leaf node. Thereafter, a valid path from the root node to replication nodes within each business object specified in the at least one request is determined if it was determined that corresponding request is valid. A replication tree is then generated based on the determined valid path. The replication tree is then traversed and an association is returned when stopping on a leaf node and a replication node is returned when traversing a node to be replicated. A retrieve by association service is executed when an association is returned, otherwise, a retrieve service is executed. Thereafter, nodes retrieved via the retrieve by association service or the retrieve service are stored in a replication store using packages having a fixed size to enable the replication store to be searched.

In an interrelated aspect, replication of at least a portion of a business object is initiated. Thereafter, a replication tree based on the business object is generated. The replication tree includes a plurality of hierarchically arranged nodes, with a root node on a first end, at least one leaf node on a second end, and at least one intermediate node disposed between the root node and the at least one leaf node. Traversal of the replication tree is initiated at the root node, the root node indicating that a SelectAll query is to be executed. Thereafter, the SelectAll query specified by the root node is executed in paging mode. Node IDs obtained from the executed SelectAll query are pushed into a replication store. Traversal of the remainder of the replication tree is continued so that a SelectAll query is executed for each replication node identified in the replication tree providing a SelectAll query, and a Retrieve By Association service is executed for each replication node in the replication tree not providing a SelectAll query.

Articles are also described that comprise a machine-readable medium embodying instructions that when performed by one or more machines result in operations described herein. Similarly, computer systems are also described that may include a processor and a memory coupled to the processor. The memory may encode one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating a technique for generating secondary persistencies in a framework such as a service-oriented business framework;

FIG. 2 is a diagram an application server architecture including an Enterprise Services Framework, an application, and a Fast Search Infrastructure;

FIG. 3 is a diagram illustrating generation of an Fast Search Infrastructure view;

FIG. 4 is a diagram illustrating a first Fast Search Infrastructure/Business Intelligence Loader; and

FIG. 5 is a diagram illustrating a second Fast Search Infrastructure/Business Intelligence Loader.

### DETAILED DESCRIPTION

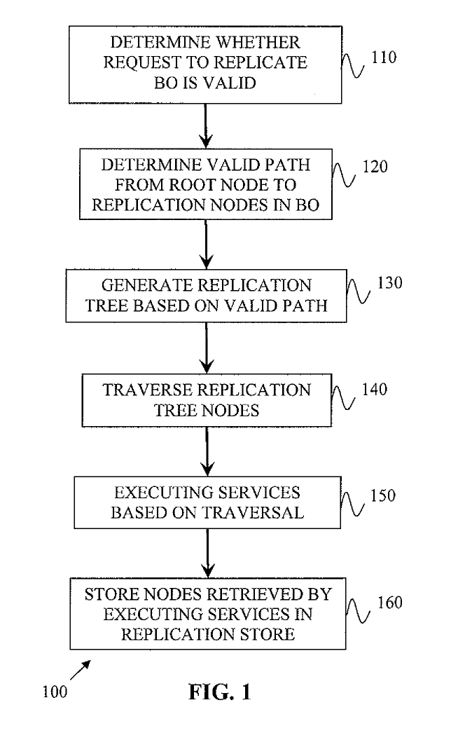

FIG. 1 is a process flow diagram illustrating a method 100, in which, at 110, it is determined whether at least one request to replicate at least one business object is valid. The business object comprising a plurality of hierarchically arranged nodes, with a root node on a first end, at least one leaf node on a second end, and at least one intermediate node disposed between the root node and the at least one leaf node. Thereafter, at 120, a valid path from the root node to replication nodes within each business object specified in the at least one request is determined if it was determined that corresponding request is valid. A replication tree is then, at 130, generated based on the determined valid path. The replication tree is then traversed, at 140, and an association is returned when stopping on a leaf node and a replication node is returned when traversing a node to be replicated. A retrieve by association service is, at 150, executed when an association is returned, otherwise, a retrieve service is executed. Thereafter, nodes retrieved via the retrieve by association service or the retrieve service are, at 160, stored in a replication store using packages having a fixed size to enable the replication store to be searched.

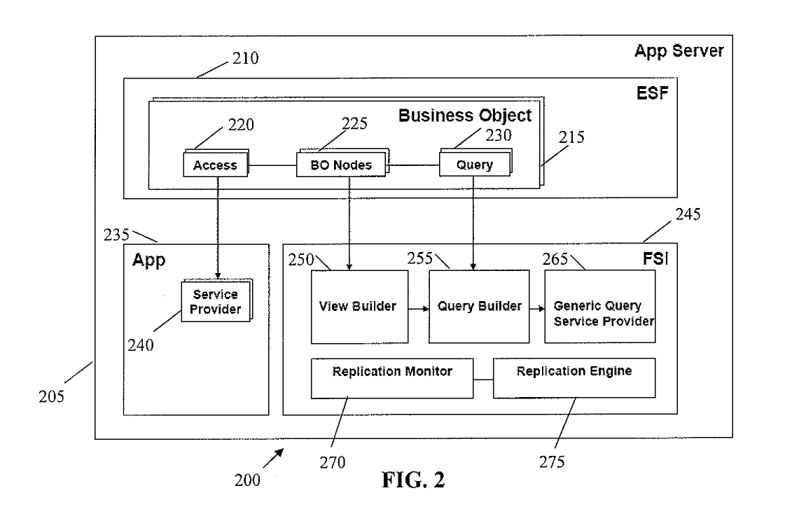

FIG. 2 is a diagram 200 illustrating an application server 205 that operates an Enterprise Services Framework (ESF) 210, an application 235, and a Fast Search Infrastructure (FSI) 245. A service provider 240 of the application 235 can have access (via an access module 220) to data encapsulated by the business object 215. Business objects and their services can defined within a central service repository which are be implemented within the Application Server 205. The FSI 245 can provide view builder 250 for providing views on one or more business objects 215 based on business object node definitions received from the business object nodes 225. A query builder 255 maps data obtained from the business object nodes 225 via the view builder 250 onto view fields that are defined by a query service definition obtained from a query module 230 of the business object. A generic query service provider 265 in the FSI 245 initiates a query to be conducted by an external search engine. The FSI 245 can also include a replication monitor 270 that monitors replication of required data objects (e.g., business object nodes), and a replication engine 275 causes the required data objects to be replicated and provides the replicated data objects to the external search engine.

Fast Search (FS) views are the main entity of the FSI. They can contain data modeling as well as view-field definitions. The view metadata can also be the base for replication—the metadata describes which data (BO Nodes and attributes) has to be replicated to the search engine. Views are used to encapsulate data modeling details (join relations between the several BO nodes) and hide the actual data sources by providing view fields which are the only components that are visible from the outside. A view represents a logical collection of data similar to database views.

A FS view can consist of the following components:
view field definitions: BO Node-Attributes visible from the outside and referenced by a user defined name.
A set of data sources: Data sources can be BO Nodes as well as FS views linked by joins

Fast Search Views (FS view) introduce reusability and can enlarge modeling capabilities. Once a FS view has been created and activated, users can reuse this view as a data source within another view. From the user's point of view, a FS view can be seen as a separate data source much like a BO Node and therefore can be loaded into the FS view Builder 250.

The view builder 250 can be a graphical tool to design views. Within the view builder 250, view fields can be defined that represent an alias for BO node-attribute pair visible from the outside. In order to support complex queries a join condition on multiple database BO nodes can be defined.

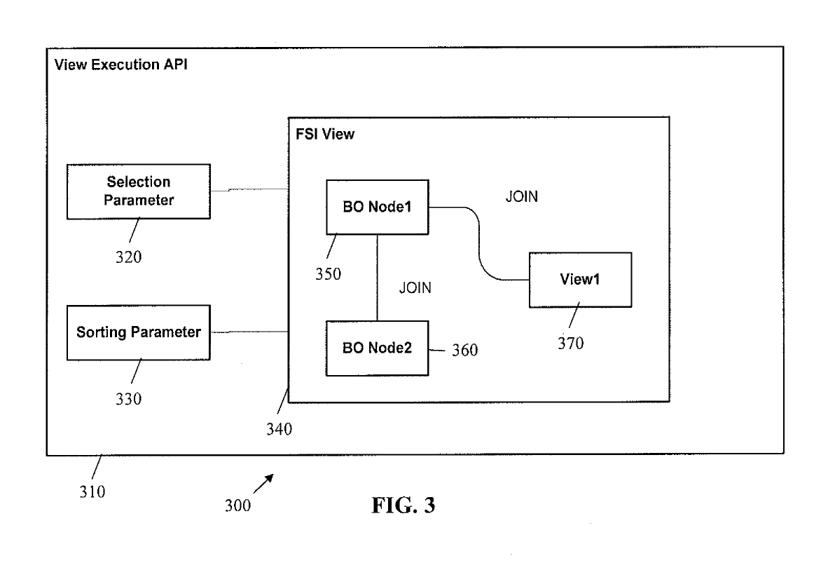

With reference to FIG. 3, a diagram 300 illustrating a schematic view execution Application Programming Interface (API) 310 is provided. In this example, selection and sorting parameters 320, 330 are mapped on view fields during execution of an FSI view 340. View1 370 of the FSI view 370 can be based on two joined BO nodes 350, 360. It will be appreciated that within the FSI view 370, BO nodes and other views can be used as data source in combination. This means, joins can be created between views and BO nodes. For a join between a BO node and a view or between two views an appropriate view field must exist within the views used as data sources. Additionally, View1 370 can be reused and subsequently handled in the same way as a BO Node. However, View1 only consists of its metadata describing the actual data source(s).

During initial replication, the keys of all entries in the application BO node can be written to an internal storage. For this purpose, the BO node has to provide a query service that delivers all keys of the node.

The replication framework reads the keys from the internal storage and the original data from the application BO node for each key and then indexes the data to the search engine.

The replication monitor 270 can provide information of the activated view metadata and the status of the replicated data. Additionally, a user may initiate a replication process via the replication monitor. The replication monitor may provide information such as current indexing processes, logs, connected search engines, and the like.

The replication engine 270 can be used to handle replication requests on node level of the same business object (e.g., the engine expects a list of nodes for which data should be replicated). There is only one boundary condition that only nodes can be replicated which take part in any view. It is also possible to hand over single node ID for which the data should be replicated into a secondary persistency.

After checking if all replication request are valid the path from the root node to the replication nodes are determined. A replication node is a business object node for which data should be replicated. All paths are unique since parent-child-associations of the business object model are used. Using those paths the replication graph is built up. Per construction the graph is a tree where all leaves are replication nodes. In addition, some or all of the intermediate nodes can also be replication nodes. The root node of the replication tree is the root node of the business object.

An iterator traverses the replication tree and returns an association (when stopping on edge) or a replication node (when stopping on node which is to be replicated). If the iterator returns an association, a core service RETRIEVE_BY_ASSOCIATION can be executed otherwise the RETRIEVE service is executed. The iterator can traverse the tree using, for example, a Depth-First Search (DFS) algorithm.

The node IDs which have been returned via RETRIEVE_BY_ASSOCIATION can be pushed into a replication store. Node IDs which are needed for retrieve or as source node IDS for RETRIEVE_BY_ASSOCIATION can be taken from the replication store. Both pushing into and taking from the replication store can utilize packages with fixed size (internal page size). Therefore all RETRIEVEs and RETRIEVE_BY_ASSOCIATIONs are executed in packages. If a RETRIEVE is performed on a leaf node, an event can be raised which triggers deleting of all node IDs in the replication store which are no longer needed. This deletion reduces memory consumption and eases swapping into a primary database if memory runs low due to a big number of node IDs.

At the beginning the replication iterator points to the root node which indicates that the SelectAll query of this node must be executed. The SelectAll is executed in paging mode, requesting one page by setting MaximumRows (SelectAll page size) and PagingActive. The returned node IDs are pushed into the replication store and the iteration through the tree starts. Whenever a replication node is to be handled the corresponding secondary persistencies are cleared before the retrieved data is written.

If the first page has been replicated the replication iterator is reset and starts again. The request of the next page via SelectAll is a little bit different. The MaximumRows and PagingActive are set, too but also StartNodeId can be filled which the last node ID of the previous page.

Depending on the desired implementation, there can be several other processing steps:

Set replication lock and check if there are other running replication processes.

Check search and classification server

Turn off search and classification delta index and set delta size to 0.

Clearing replication queue from failed updater entries

Set load status to “loading”

Depending on the desired implementation, there can be additionally be several post-processing steps:

Replicate data which were queued during replication process

Turn on search and classification delta index and set delta size to 1.

Release replication lock

Set load status to “ready”

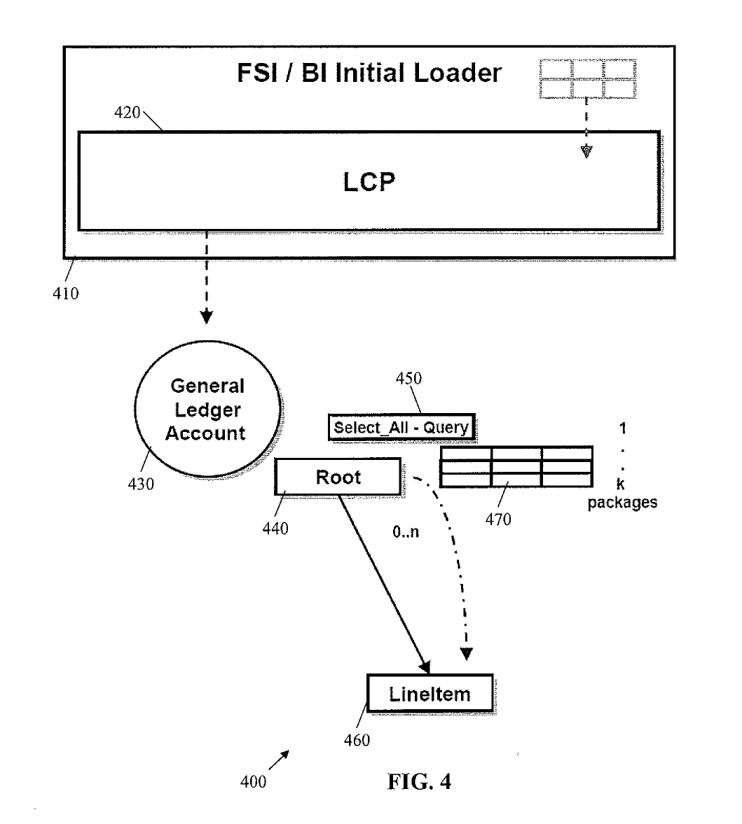

With reference to FIG. 4, a diagram 400 is illustrated in which an FSI/Business Intelligence (BI) Loader 410 uses a Local Client Proxy (LCP) 420 for tree walk approach to extract data from a General Ledger Account 430 business object. A SELECT_ALL query 450 at a root level 440 is used for data provision in a privileged mode. At the root level, the query result is packaged 470. However, due to cardinality 0 . . . n, a data explosion can occur at a child node level 460 because a tree walk from the root level 440 is not memory controllable due to missing packaging support of RETRIEVE_BY_ASSOCIATION. In addition, all data will be stored in a read buffer within the BO service providers, which results in high memory consumption and reduced performance. Furthermore, IN_NODE_IDS-based access via RETRIEVE and RBA can lead to suboptimal SQL access with FOR ALL ENTRIES clause.

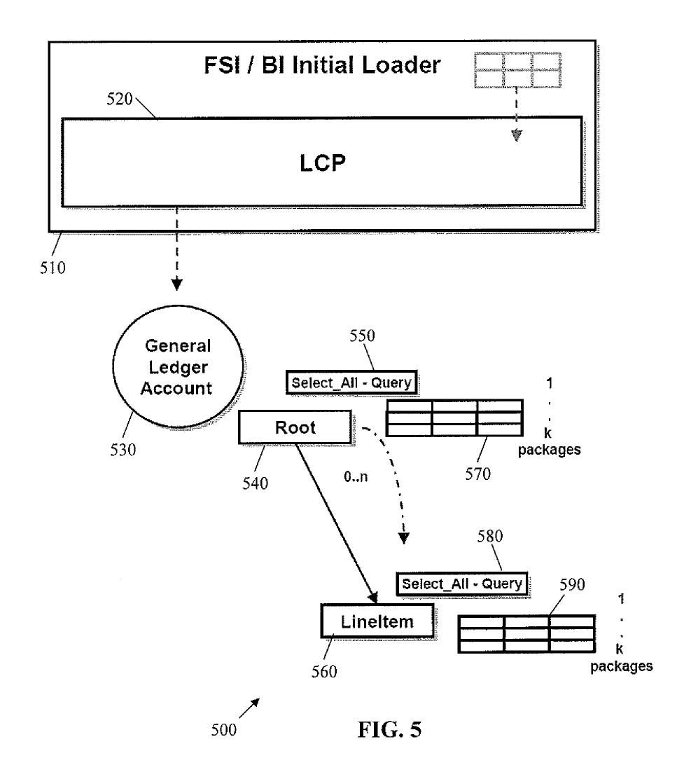

FIG. 5 illustrates a diagram 500 in which an FSI/BI Loader 510 also uses a LCP 520 to extract data from a General Ledger Account 530 business object. However, in contrast to the arrangement of FIG. 4, FSI calls SELECT_ALL query 550, 580 on each FSI-relevant BO node 540, 560 with IN_FILL_DATA=X′ and paging 570. 50-based on START_NODE_ID. In addition, FSI passes IN_REQUESTED_ATTRIBUTES in order to avoid determination of transient fields in BO service provider. With this arrangement, no RETRIEVE and RBA calls are involved, flexible paging is possible on BO node level, only requested fields are retrieved (no cross-BO communication is required), and mass selection of data without FOR ALL ENTRIES is possible (SQL statements with optimal performance can be used).

Table 1 is an example of performance measure of BO AccountingDocument that requires obtaining data from 1,000 root node instances using conventional techniques.

TABLE 1

| Core | | | |
|---|---|---|---|
| Service Call | Runtime | Runtime per Row | Memory Consumption |
| QUERY: | 9.735 μs | 10 μs/row | 457.840 byte |
| SELECT_ALL | | | |
| RETRIEVE | 1.300.567 μs | 1.301 μs/row | 14.643.824 byte |
| Total | 1.310.302 μs | 1.310 μs row | 15.101.664 byte |

The disadvantages with the example of Table 1 is that too much data is read during RETRIEVE: transient fields determined via LCP cross BO communication (e.g., CompanyID of MOM BO) which must not be used in FSI views of AccountingDocument. In addition, a read buffer is built up internally during RETRIEVE, and selection from database table is performed via FOR ALL ENTRIES.

Table 2 illustrates a second example using the techniques described herein that relates to corresponding DB-Table of BO Accounting Document, Root Node, DDIC structure length: 1.182, ABAP length: 2.158, and which relates to obtaining data of 1,000 root node instances ( . . . UP TO 1000 ROWS).

TABLE 2

| | | | Runtime |
|---|---|---|---|
| SQL Statement | | Runtime | per Row |
| 1. | SELECT key ... UP TO 1000 ROWS | 3.269 μs | 10 μs/row |
| | (SELECT ALL) | | |
| 2. | SELECT* ... FOR ALL ENTRIES IN keys | 57.943 μs | 58 μs/row |
| | (RETRIEVE) | | |
| | SELECT * UP TO 1000 ROWS | 35.457 μs | 35 μs/row |

As can be appreciated from Table 2, pure SELECT of 1,000 root node data rows takes 35 ms (without proxy mapping), as compared to transactional core services requiring 1,310 ms (a factor of 37 slower).

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments may be within the scope of the following claims.

What is claimed is:

1. An article comprising a tangible machine-readable medium embodying instructions that when performed by one or more machines result in operations comprising:
determining whether at least one request to replicate at least one business object is valid, the business object comprising a plurality of hierarchically arranged nodes, with a root node on a first end, at least one leaf node on a second end, and at least one intermediate node disposed between the root node and the at least one leaf node;
determining a valid path from the root node to replication nodes within each business object specified in the at least one request if it is determined that corresponding request is valid;
generating a replication tree based on the determined valid path;
traversing the replication tree and returning an association when stopping on a leaf node and returning a replication node when traversing a node to be replicated;
executing a retrieve by association service when an association is returned, otherwise, executing a retrieve service; and
storing nodes retrieved via the retrieve by association service or the retrieve service in a replication store using packages having a fixed size to enable the replication store to be searched.

2. An article as in claim 1, wherein the tangible machine-readable medium further embodies instructions that when performed by one or more machines result in operations comprising:
storing keys of all entries in a node of the business object in an internal storage;
reading the keys from the internal storage and the corresponding original data for the business object node; and
indexing the original data to a search engine.

3. An article as in claim 1, wherein only nodes used in a view are replicated.

4. An article as in claim 1, wherein all leaves of the replication tree are replication nodes.

5. An article as in claim 4, wherein at least one intermediate node is a replication node.

6. An article as in claim 1, wherein the replication tree is traversed using a tree walk approach.

7. An article as in claim 6, wherein the replication tree is traversed using a Depth-First Search algorithm.

8. An article as in claim 1, wherein the tangible machine-readable medium further embodies instructions that when performed by one or more machines result in operations comprising:
deleting all stored node IDs which are no longer needed when a retrieve service is executed on a leaf node.

9. A computer-implemented method comprising:
determining whether at least one request to replicate at least one business object is valid, the business object comprising a plurality of hierarchically arranged nodes, with a root node on a first end, at least one leaf node on a second end, and at least one intermediate node disposed between the root node and the at least one leaf node;
determining a valid path from the root node to replication nodes within each business object specified in the at least one request if it is determined that corresponding request is valid;
generating a replication tree based on the determined valid path;
traversing the replication tree and returning an association when stopping on a leaf node and returning a replication node when traversing a node to be replicated;
executing a retrieve by association service when an association is returned, otherwise, executing a retrieve service; and
storing nodes retrieved via the retrieve by association service or the retrieve service in a replication store using packages having a fixed size to enable the replication store to be searched.

10. A computer-implemented method as in claim 9, further comprising:
storing keys of all entries in a node of the business object in an internal storage;
reading the keys from the internal storage and the corresponding original data for the business object node; and
indexing the original data to a search engine.

11. A computer-implemented method as in claim 10, wherein only nodes used in a view are replicated.

12. A computer-implemented method as in claim 10, wherein all leaves of the replication tree are replication nodes.

13. A computer-implemented method as in claim 12, wherein at least one intermediate node is a replication node.

14. A computer-implemented method as in claim 10, wherein the replication tree is traversed using a tree walk approach.

15. A computer-implemented method as in claim 14, wherein the replication tree is traversed using a Depth-First Search algorithm.

16. A computer-implemented method as in claim 10 further comprising:
deleting all stored node IDs which are no longer needed when a retrieve service is executed on a leaf node.

17. An article comprising a tangible machine-readable medium embodying instructions that when performed by one or more machines result in operations comprising:
initiating replication of at least a portion of a business object;
generating a replication tree based on the business object, the replication tree comprising a plurality of hierarchically arranged nodes, with a root node on a first end, at least one leaf node on a second end, and at least one intermediate node disposed between the root node and the at least one leaf node;
initiating traversal of the replication tree at the root node, the root node indicating that a SelectAll query is to be executed;
executing the SelectAll query specified by the root node in paging mode;
pushing node IDs obtained from the executed SelectAll query into a replication store; and
continuing traversal of the remainder of the replication tree, executing a SelectAll query for each replication node identified in the replication tree providing a SelectAll query, and executing a Retrieve By Association service for each replication node in the replication tree not providing a SelectAll query.
